(19) United States
(12) Patent Application Publication
(10) Pub. No.: US 2002/0120675 A1
(43) Pub. Date: Aug. 29, 2002

(54) METHOD OF TRANSFERRING MEDIA FILES OVER A COMMUNICATIONS NETWORK

(76) Inventors: STEWART NEIL EVERETT, GLOUCESTERSHIRE (GB); JAMES BARRS, GLOUCESTERSHIRE (GB); JAMES AUGUSTINE BOOTH, GLOUCESTERSHIRE (GB); IAN DAVID MONTGOMERY, GLOUCESTERSHIRE (GB)

Correspondence Address: CLIFFORD W BROWNING, WOODARD EMHARDT NAUGHTON, MORIARTY & MCNETT BANK ONE CTR TOWER, 111 MONUMENT CIRCLE SUITE 3700, INDIANAPOLIS, IN, 46204

(21) Appl. No.: 09/355,548

(22) PCT Filed: Jan. 26, 1998
(86) PCT No.: PCT/NZ98/00005

(30) Foreign Application Priority Data
Jan. 29, 1997 (NZ) 314150

(51) Int. Cl. G06F 15/16

(52) U.S. Cl. 709/203; 709/219

(57) ABSTRACT

A method of transferring media files over a communications network, typically the Internet. The files are divided by the provider computer into a series of encoded files which are maintained in the provider computer and are transferred over the communications network in a specific sequence to receiving computer. A user loadable program is also maintained in the provided computer and that together with all file types contributing to the content of the communication are also transferred over the communications network to the receiving computer. The received files can then be reproduced by the receiving computer in the correct sequence.

### FIELD OF THE INVENTION

The present invention relates to a method of transferring and reproducing media and other file types over a communications network in a prearranged sequence/order In particular but not exclusively the present invention relates to a computerised method of transferring and reproducing media or other file types over the Internet.

### BACKGROUND TO THE INVENTION

With regard to media files, there are currently several available computerised methods of transferring media files over communications networks, such as the Internet, but they all have specific disadvantages. Some known downloadable audio file techniques rely on sending an audio file as a package of data or digitised audio, and the receiver must wait until the media file is fully loaded before complete reproduction of the file can commence. Particularly when applied to the Internet the length of time taken to download a media file can be such that the user is liable to disconnect before the media file has downloaded and can be played. In addition, since the time taken in downloading is often a chargeable item, the cost of downloading can be significant.

“Live Stream” type, methods of communicating media files such as Real Audio™ or Shockwave™ for example, transfer compressed audio files which are decoded and played as the receiver receives them. However these methods of transferring compressed audio files require large areas of bandwidth and appropriate decoding software at the receiving end. Another disadvantage with Real Audio™ systems is that they require a minimum of a 28.8 Kbps modem for adequate sound reproduction. Such systems are generally used for broadcasting by radio stations for concert broadcasts and cannot be readily incorporated into an Internet World Wide Web site. The Shockwave™ system is recognised as being expensive and complicated for Internet developers to use and requires the end user to have previously downloaded the necessary plug-in. Consequently the use of this system is limited MDI techniques are also utilised for generating audio. MDI files, by their nature are smaller than files which attempt to store an actual sound wave pattern in digitised format. This means they can be readily transferred over a network faster than other types of audio files. However, MDI files do not reproduce pre-recorded audio sounds. Instead, a set of instructions following a standard known as GM MDI is executed by the computer through a sound card activating notes on particular instruments whose approximate sound characteristics have been stored on the sound cards. The quality of the sound card, or a device attached to a sound card which is capable of accepting a GM MIDI set of instructions, is highly variable and is dependent largely on price. Consequently to obtain a realistic sound effects requires expensive pieces of hardware. The reproduction of the audio files is generally of a poor quality, because of the nature of FM synthesis in the “low end” mass-market sound card. Even with a “high end” sound card, the quality of reproduction of audio files is limited to the GM MDI pre-sets and such pre-sets allow only for basic instrumental sounds which are suitable for limited applications, computer games and the like.

It is therefore apparent that a need exists for a system which is capable of transferring and playing or reproducing media files over a communications network, such as the Internet, which will be compatible with the provision of Web pages and which will shorten the access time in terms of waiting for the media file to start playing on a user's computer terminal.

It is also apparent that a need exists for a system which is capable of transferring and reproducing all types of files over a communications network, such as the Internet, which will make optimum use of the available bandwidth by allowing the download of all said files to be controlled by a set of sequencing instructions which determines the download order for the entire content of the communication (Web site). This content is likely to be files of an HTML or similar type, text files, image files, multimedia files and audio files.

### OBJECT OF THE INVENTION

It is an object of this invention to provide a method of transferring and playing media files over a communications network which will obviate or at least minimise the above disadvantages. It is also an object of this invention to provide a method of transferring and reproducing all types of files over a communications network by way of a synchronised delivery which will obviate or at least minimise the disadvantages of current methods of transferring data.

### DISCLOSURE OF THE INVENTION

In broad terms the invention comprises a method of transferring and reproducing or playing a media file or other file type over a communications network, comprising.

(a) dividing said media file into a sequence of encoded files,

(b) maintaining said encoded files in a provider computer means,

(c) transferring in a specific sequence said encoded files to a receiving computer means, and

(d) transferring in a specific sequence all file types contributing to the content of the communication,

wherein, after each said encoded or other file type has been received by said receiving computer, the encoded or other file type will be decoded and playing or reproduction of said decoded file can commence before or during the loading of the next sequential encoded file or other file type, the construction and arrangement being that the sequence of decoded files can be reproduced or played in a manner substantially identical to said media or other file type and reproduced to adhere to the sequence.

Preferably the step (b) further includes maintaining a user loadable program in the provider computer means and step (c) further comprises transferring the program to the receiving computer means.

Preferably the program is a Java applet.

Preferably playing of the media file or other file type can commence prior to the completion of the reception of the second encoded file or other file type in the sequence.

In another aspect the invention also comprises a receiving computer system including means for reproducing or playing a media file or other file type transmitted over a communications network from a provider computer means having means to divide and maintain a media file or other file type into a sequence of encoded files and to transfer the encoded files and all files contributing to the content of the communication in a specific sequence over the communications network to the receiving computer means, wherein, after each said encoded or other file type has been received by said receiving computer, the encoded or other file type will be decoded and playing or reproduction of said decoded file can commence before or during the loading of the next sequential encoded file or other file type, in a manner that decoded files can be reproduced or played in a manner substantially identical to said media or other file type and reproduced to adhere to the sequence.

In a yet further aspect, the invention comprises a provider computer means adapted to transfer a media file or other file type over a communications network, including means to divide a media file into a sequence of encoded files and to maintain the encoded files in the provider computer means and to transfer the encoded files and other file types including a user loadable program in a specific sequence over a communications network to a receiving computer means.

Preferably the provider computer means includes means to maintain a user loadable program in the provider computer means, and to transfer the program to the receiving computer means.

Preferably the media file is any collection of data such as an audio file, an image file, an HTML file, a VRML/3D World file, a text file, or a filter (which modifies other media).

The kernel (engine) of the software can be seen as a transferer of data (media) and may be described by terms more closely associated with a specific field of use, for example: ‘broadcasting system’, for purposes of displaying media files over a communication network, or ‘data gatherer/collator’ for collecting and assembling data from a holding point to a viewing terminal.

### BRIEF DESCRIPTION OF THE DRAWINGS

One preferred method of transferring and reproducing a media or other file type over a communications network will now be described with the aid of the accompanying drawings, wherein:

FIG. 1 is a block diagram of the preferred method of operation of the system;

FIG. 2 is a flow chart showing basic system operation;

FIG. 3 depicts one form of pseudo code for the applet of the preferred embodiment.

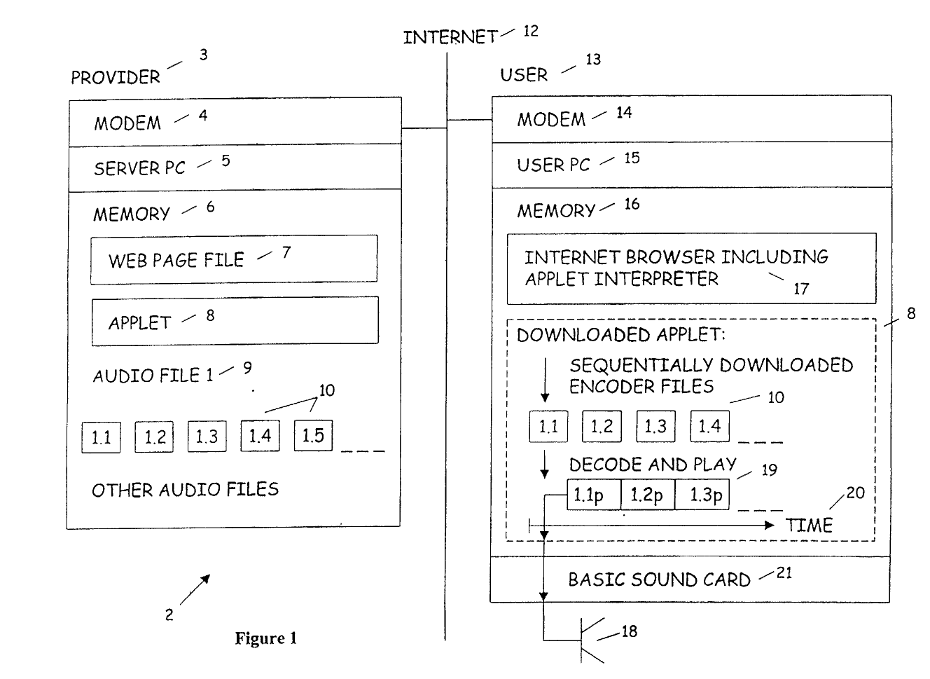

The system 2 as shown in general block diagram in FIG. 1 comprises a provider 3 including a provider modem 4, a server 5 and provider memory 6 containing a web page 7, an applet 8 (which is preferably a file of Java instructions) and one or more media files 9 encoded as sequential encoded files or other types 10. The provider 3 may be connected to a plurality of users 13 by a communications network 12 such as the Internet.

The user system 13 includes a user modem 14, a user computer 15 and a user memory 16 containing an Internet browser 17. The browser 17 includes an interpreter which interprets and executes the applet 8

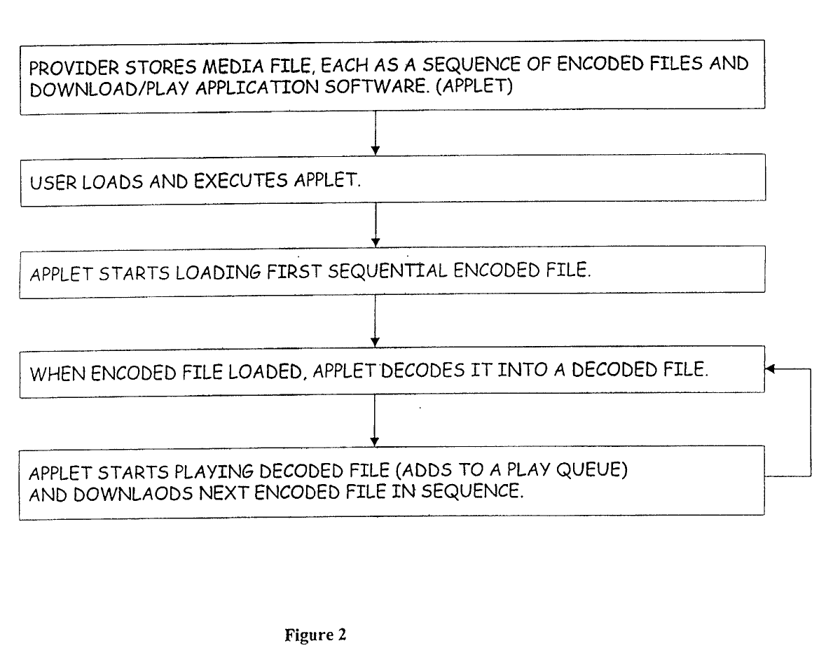

As illustrated in FIGS. 1 and 2, a provider computer 3 maintains in the provider memory 6, a web page file 7, an applet 8 and one or more media files 9 in the form of encoded files or other file types 10 which may be audio, video, graphical, html, and other known types of files which contribute to the content of the communication over a communications network. The encoded files or other file types are obtained by the applet 8 from the server 5 and represent the media file 9 as a number of sections, each of which is encoded or compressed into an encoded file.

The user system 13 can download the web page 7 and the applet 8 of the provider 3 by using the Internet 12 and user and provider modem interfaces 14 and 4 respectively. The web page 7 provides the user 13 with the option of downloading and reproducing one or more media files 9 Upon selecting a file 9, the applet 8 now resident in the user memory 16 (shown in phantom outline) is executed by the user's browser software 17. The applet 8 is preferably written in Java for the initial purpose as an internet application, although any language interpretable by the browser 17 may be employed as long as it supports media files. Alternatively, the user 13 may use resident executable application software to download and reproduce the encoded files 10

Alternatively the initial web page 7 and the applet 8 of the provider 3 can be downloaded and once downloaded, the applet 8, executed by the browser software 17 can control the further download of all file types, media or otherwise, that form the whole of the content of the communication (web pages and their content).

The applet 8 starts downloading the first of the sequential encoded files or other file types 10 [1.1], and waits until this is filly loaded into the memory 16 of the user computer. The applet 8 then decodes or decompresses the encoded file 10 [1.1] into a decoded file 19 [1.1p] and commences playing or reproducing the file. At the earliest point, normally in conjunction with playing the loaded files, the applet 8 then starts loading the next sequential encoded file or other file type 10 [1.2] [1.3], and at the completion of loading each encoded file or other file type 10, the applet 8 decodes it into a decoded file 19 and can commence playing or reproducing it at such point that the sequence dictates. In practice the decoded files 19 [1.1 p] [1.2p]. . . will be added to a queue which will enable each decoded file 19 to be played in a first in, first out (FIFO) sequence such that one file, for instance [1.1p] runs into the next [1.2p] if required to do so by the sequencing arrangement. The media file or other file type 9 will therefore appear to be played continuously without pauses between decoded. files. This system therefore requires a user 13 to supply only a basic sound card 21 (for purposes of audio) and modem 14 to play a high quality media (audio) file 9. Alternatively the files can be arranged to play or be reproduced according to a sequence where timed spacing is employed. In the event of this, the next file 19 in the queue will still be downloaded at the earliest opportunity and will remain in the memory 16 of the user computer until such time as it is required by the sequencing information.

The timing of the loading of the encoded files or other file types 10 and playing of the decoded files 19 can be seen at 20 in FIG. 1 where the first decoded file 19 [1.1p] does not start playing until after its corresponding encoded file 10 [1.1] has been fully loaded and decoded. Loopback points are defined within the sequencing information, indicating suitable phrases to repeat in the event of being unable to progress further in the sequence (typically, although not necessarily because a required media file or other file type 10 is not yet completely downloaded 10 or decoded 19). The presence and availability of loopback points give the impression of continuous output for purposes of achieving a continuous flow.

The user 13 has only to wait for the loading and decoding of the first encoded file or other file type 10 [1.1] and does not have to wait for the loading of the complete media or other file types before the media file 9 or other file type commences playing or is reproduced. The partitioning of one complete media file removes the need for the complete media file to be loaded prior to playing.

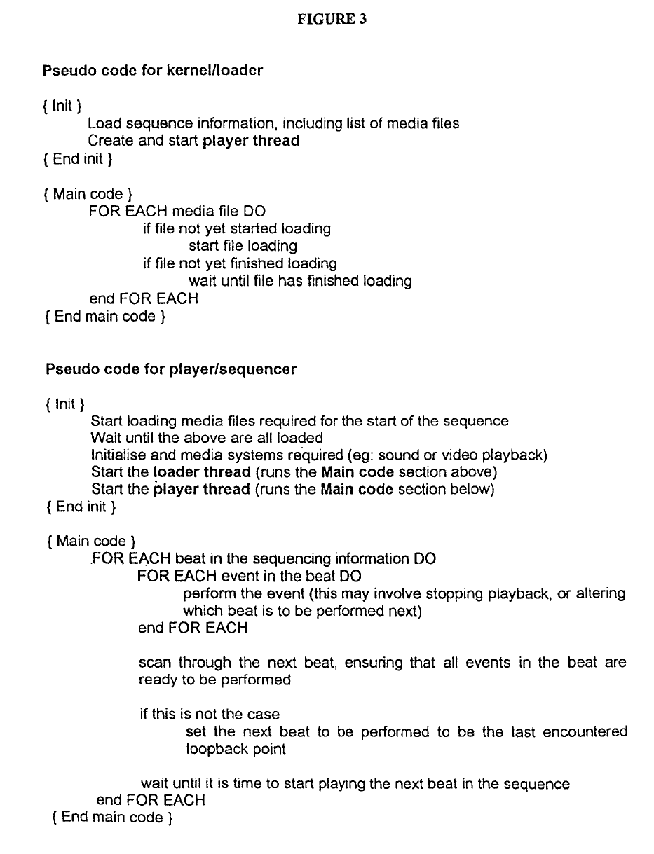

Preferably the Java applet 8 comprises two elements or “threads” which run simultaneously during the life span of the Java applet (as shown in FIG. 3). The first element is the kernel or loader which starts the second element and loads the encoded files 10 from the provider 3. The second element is a player/sequencer which sits in a loop continuously monitoring the state of the encoded and decoded files 10 and 19. During the loop, if the player/sequencer detects that a decoded file is available for playing (i.e. an encoded file has been loaded and decoded) it will play the file (at the start of the loop to maintain synchronisation) as long as the file obeys a set of rules defined for it. This set of rules defines the sequencing of the files. This element also maintains a counter which represents the position in the media file 9. This counter, combined with the check for file playability and the logic of the sequencing rules, allows the applet to intelligently sequence the decoded files providing an effective sequencing unit.

Referring to FIGS. 2 and 3 when the applet 8 is executed, the kernel starts the player/sequencer running such that both elements run simultaneously. The kernel initially loads the sequence information about the media file(s) 9 to be downloaded, then starts loading the first encoded file or other file type 10 and sits in a loop waiting for each file 10 in the sequence to load.

The sequencing information is timed by way of beats, each allowing for a set of events which happen within the beat. Beats happen at regular distinct intervals defined within the sequencing information. A beat can be given a different value at a specific point within the sequence as an event. This allows a combination of media files of differing lengths and rhythms to be used within the same arrangement. Events are actions that can be performed by the player. Some potential actions are:

start or stop playing a media file

alter the contents of a media file (e.g.: blurring an image, applying reverb to a sound)

setting properties of a media file (e g . setting the level of fog in a 3D world)

stopping playback

altering the next beat to be played (e.g.: jumping, repeating sections)

act on input from outside the player. For instance, input from the user, or from a coexisting piece of software, or from a peripheral device attached to the computer, could result in the player performing one or more actions (events). The input need not arrive at the same point as the event is processed by the player, but could be received earlier and stored until needed.

synchronous control—in addition to events which act on external input, the player itself can respond directly and immediately to specific commands. These might include the ability to suspend playback (pause), or to disable and re-enable specific types of events.

Synchronising of sound files and image files

Synchronising of sound filed and HTML pages

After an encoded file or other file type 10 has loaded, the kernel decodes the encoded file 10 into a corresponding decoded or playable file 19. The kernel then starts loading the next encoded file 10 in the sequence.

Meanwhile the player/sequencer loads the first decoded file 19 [1.1p] required for the start of the sequence and initialises any media systems required such as sound cards or video playback systems. The player then sits in a loop receiving instructions from the sequencing information loaded by the kerneil loader. If the player is able to perform the events contained in each beat as instructed by the sequencing information, it does so while scanning through the next beat to ensure the events contained in that next beat are able to be performed. If the events in the next beat can not be performed because the next encoded file or other file type 10 has not been fully downloaded or decoded, the player sets the next beat to be performed to be the last encountered loopback point. After finishing one beat, the player waits for the next beat to load and repeats this cycle until all available beats in the sequencing information have been performed on the decoded files 19.

As a result of the present invention, many of the deficiencies previously inherent in the transmission of media files over transmission networks have been minimised including the problems of transmitting all file types in a predetermined order over transmission networks. In particular some of the advantages obtained are:

a. Special decoding software does not have to be installed by the user.

b. Considerably less bandwidth is required for transmission of a media file than live stream transmission.

c. The user does not have to wait for the whole media file such as a piece of music or complete spoken paragraph, to be downloaded before playing commences.

d. Actual pre-recorded sound waves are reproduced and not computer generated sounds

e. Standard readily available hardware can be utilised by the receiver

f. Any combination of files can be sequenced and thus the arrangement of the download of the files can be pre-designed to optimise the resources of the bandwidth.

The foregoing describes a preferred form of the invention. Having read the description it will be apparent to those skilled in the art that alterations and modifications can be made without departing from the basic concept of the invention. All such alterations and modifications are intended to be incorporated within the scope hereof.

1. A method of transferring and reproducing or playing a media file or other file type over a communications network, comprising:
(a) dividing said media file into a sequence of encoded files,
(b) maintaining said encoded files in a provider computer means,
(c) transferring in a specific sequence said encoded files to a receiving computer means, and
(d) transferring in a specific sequence all file types contributing to the content of the communication,
wherein, after each said encoded or other file type has been received by said receiving computer, the encoded or other file type will be decoded and playing or reproduction of said decoded file can commence before or during the loading of the next sequential encoded file or other file type, the construction and arrangement being that the sequence of decoded files can be reproduced or played in a manner substantially identical to said media or other file type and reproduced to adhere to the sequence.

2. The method of claim 1, wherein step (b) further includes maintaining a user loadable program in the provider computer means and step (c) further comprises transferring the program to the receiving computer means.

3. The method of claim 2, wherein the program is a Java applet.

4. The method of claim 1, wherein playing of the media file or other file type can commence prior to the completion of the reception of the second encoded file or other file type in the sequence.

5. A receiving computer system including means for reproducing or playing a media file or other file type transmitted over a communications network from a provider computer means having means to divide and maintain a media file or other file type into a sequence of encoded files and to transfer the encoded files and all files contributing to the content of the communication in a specific sequence over the communications network to the receiving computer means, wherein, after each said encoded or other file type has been received by said receiving computer, the encoded or other file type will be decoded and playing or reproduction of said decoded file can commence before or during the loading of the next sequential encoded file or other file type, in a manner that decoded files can be reproduced or played in a manner substantially identical to said media or other file type and reproduced to adhere to the sequence.

6. A provider computer means adapted to transfer a media file or other file type over a communications network, including means to divide a media file into a sequence of encoded files and to maintain the encoded files in the provider -computer means and to transfer the encoded files and other file types including a user loadable program in a specific sequence over a communications network to a receiving computer means.

7. The provider computer means of claim 6, including means to maintain a user loadable program in the provider computer means, and to transfer the program to the receiving computer means.
